(19) United States
(12) Patent Application Publication
(10) Pub. No.: US 2013/0329528 A1
(43) Pub. Date: Dec. 12, 2013

(54) MECHANICAL ANIMATIONS WITH ELECTRONIC DISPLAY

(71) Applicant: Peter Botten, Lakewood, OH (US)

(72) Inventor: Peter Botten, Lakewood, OH (US)

(21) Appl. No.: 13/914,722

(22) Filed: Jun. 11, 2013

Related U.S. Application Data
(60) Provisional application No. 61/658,039, filed on Jun. 11, 2012.

(51) Int. Cl. G04B 19/00; G04B 19/26

(52) U.S. Cl. CPC G04B 19/00; G04B 19/268
USPC 368/18; 368/223; 368/15

(57) ABSTRACT

Provided is an apparatus for projecting an electronic image. The apparatus includes at least one of a static image and a mechanically-animated object disposed within a framed region. An electronic display device displays a computer-generated image adjacent to the at least one of the static image and the mechanically-animated object within the framed region to establish an artistic composition. The computer-generated image includes content that is related to, and supplements content included in the at least one of the static image and the mechanically-animated object to provide an adaptable context to the at least one of the static image and the mechanically-animated object. A controller controls the images displayed by the electronic display.

### CROSS-REFERENCE TO RELATED APPLICATIONS

This application claims the benefit of U.S. Provisional Application No. 61/658,039, filed Jun. 11, 2012, which is incorporated in its entirety herein by reference.

### BACKGROUND OF THE INVENTION

1. Field of the Invention

This application relates generally to a method and apparatus for controlling securely publishing medical information relating to a patient onto a computer readable medium, and more specifically to method and apparatus for encrypting medical information of a patient

2. Description of Related Art

Time keeping devices such as tall clocks, for example, often include mechanized animations to depict objects in motion. More advanced presentations may include a background to provide the moving object with some degree of context. For example, a still image of the ocean can be presented in the background with waves placed as foreground. In another example, the night sky may be presented as the background while the foreground includes an image of clouds.

Mechanical animations are often included in art work, such as, rocking sailboats placed on a printed or painted depiction of the ocean, horses galloping in fields, men sawing wood in the forest, or a moon in motion in the night sky. In the past, these mechanical animations were the only means of showing objects in motion. Thus, combinations of still images and mechanical animations have been previously used to depict a scene with an object in motion to enhance realism and draw attention to the animated object.

However, typical tall clocks, other time keeping pieces, and artwork in general that have utilized such displays are static in their presentation and require the physical removal of the mechanical animations or background images to change the appearance of the artwork. In other words, although the mechanized object may move to create an animated appearance, the combination of the animated object along with the still image in the background is fixed. In order to change the appearance of artwork with mechanical animations, the still image and/or the mechanical animations must be physically removed and manually replaced with a new mechanical animation and still image to change the appearance of the display.

As another example, conventional lunar animations have typically involved a rotating moon dial 3, shown in FIG. 5, to indicate the current phase of the moon. The traditional mechanical methods have required two moons 1, 2, to be painted on the moon dial 3 approximately 180° apart from each other. The moon dial 3 is incrementally rotated once per day, achieving a full 360° rotation in approximately 60 days. At the beginning and end of the lunar phase, each of the two moons 1, 2 are partially concealed by two semicircular masks 4, 5 extending from the clock face 6 over a portion of the moon dial 3, creating the visible impression of a partial moon. However, such an animation only shows the phase of the moon, not the correct position of the moon in the sky.

### BRIEF SUMMARY OF THE INVENTION

There is a need in the art for an attractive art piece including a mechanical animation that can be featured in a room with a traditional furnishing, piece of artwork. For example, a static piece of art may be combined with an electronic (e.g. digital) display that displays computer-generated images, and optionally a mechanically-animated object that can optionally be displayed by the electronic display instead of being physically present, to create an updated but yet aesthetically pleasing and easily updatable image that can still be utilized in a traditional environment, such as a classically decorated living room.

By combining an electronic display with a still image layer and a mechanical animation, the still image in the background can be easily updated or modified. In some embodiments, a virtual (e.g., displayed on the electronic display) image showing a mechanical animation and an optional foreground image may be updated with an electronic projection or a back lite display. Specific electronic image changes may be due to a user selection, performed automatically using a calendar and clock with images associated with particular time periods, or received from an external system over a computer network, cable system, or radio system.

According to one aspect, the subject application involves an apparatus for projecting an electronic image. The apparatus includes at least one of a static image and a mechanically-animated object disposed within a framed region. An electronic display device displays a computer-generated image adjacent to the at least one of the static image and the mechanically-animated object within the framed region to establish an artistic composition. The computer-generated image includes content that is related to, and supplements content included in the at least one of the static image and the mechanically-animated object to provide an adaptable context to the at least one of the static image and the mechanically-animated object. A controller controls the images displayed by the electronic display.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF SEVERAL VIEWS OF THE DRAWING

The invention may take physical form in certain parts and arrangement of parts, embodiments of which will be described in detail in this specification and illustrated in the accompanying drawings which form a part hereof and wherein:

FIG. 1 shows a tall clock with an artwork section that includes a mechanical animation and layered artwork;

FIG. 2 shows an enlarged view of an upper portion of the tall clock appearing in FIG. 1, including a clock face and the artwork section;

FIG. 3 shows a side view of an embodiment of an artwork section including a mechanical animation, a transparent background image, and a through-projection electronic display, where an electronically generated image is transmitted from a source located internally of the artwork section;

FIG. 4 shows a side view of another embodiment of an artwork section including a mechanical animation, a background image, and front projection electronic display, where an electronically generated image is transmitted from a projector or other source located externally of the artwork section; and

FIG. 5 shows an example of a conventional lunar animation.

### DETAILED DESCRIPTION OF THE INVENTION

Certain terminology is used herein for convenience only and is not to be taken as a limitation on the present invention. Relative language used herein is best understood with reference to the drawings, in which like numerals are used to identify like or similar items. Further, in the drawings, certain features may be shown in somewhat schematic form.

It is also to be noted that the phrase “at least one of”, if used herein, followed by a plurality of members herein means one of the members, or a combination of more than one of the members. For example, the phrase “at least one of a first widget and a second widget” means in the present application: the first widget, the second widget, or the first widget and the second widget. Likewise, “at least one of a first widget, a second widget and a third widget” means in the present application: the first widget, the second widget, the third widget, the first widget and the second widget, the first widget and the third widget, the second widget and the third widget, or the first widget and the second widget and the third widget.

FIG. 1 shows a tall clock 110 (e.g. grandfather clock) with a clock dial 120 and an artwork section 130. The artwork section 130 is disposed vertically above the clock dial 120, and is curved along its bottom to avoid concealing any portion of the clock dial 120 when viewed from by an observer standing in front of the tall clock 110. According to alternate embodiments, the artwork section 130 can be rectangular in shape, but arranged behind the clock dial 120 to again avoid concealing any portion of the clock dial 120 from the view of an observer in front of the tall clock 110. According to yet other embodiments, the artwork section 130 can encompass a portion of the clock dial 120 or other portion of the tall clock 110 where a decorative aspect is desired. The perimeter of the artwork section 130 is considered to be a framed region, and can optionally include a perimeter established by a framing material made from wood, metal, or a synthetic material such as plastic, for example. However, even the absence of a distinct frame, the artwork section 130 or any of the regions where the decorative aspects described herein are to appear are considered to be a framed region.

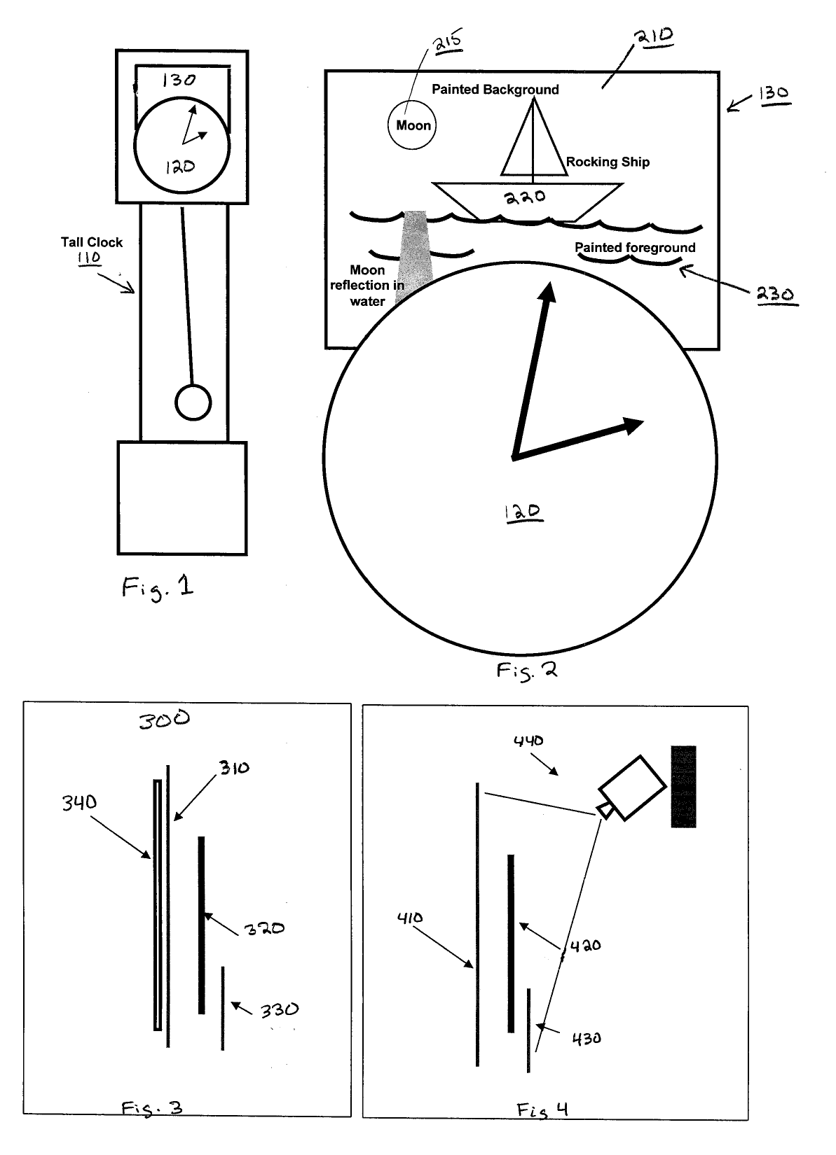

FIG. 2 shows an enlarged rendering of the clock dial 120 and artwork section 130 appearing in FIG. 1, showing a static image which, in this case, is a background image 210 including the moon 215. A mechanically animated object 220 also appears in the artwork section 130, and in the present example appears as a rocking sailing ship. The animated object 220 can be mechanically driven by any suitable actuator or driver such as a reciprocating motor, a spring driven arm extending through the background image 210, and the like.

An optional foreground image 230 also appears in the artwork section 130, and in the present example is also a static image. The foreground image 230 may be placed between a viewer standing in front of the tall clock 110 observing the clock face 120 and the mechanical animation 220, while the background image 210 may be placed behind the mechanical animation 220, relative to the viewer. In other words, the mechanical animation 220 is disposed between the background image 210 and the foreground image 220. Background and foreground images may include painted works of art, reproduction prints, printed matter, etc. . . . These images may be, for example, a seascape background with foreground of waves as shown in FIG. 2. According to other embodiments, the images can include a star-lit night background with a foreground of clouds.

Other embodiments of the artwork section 130, with mechanical animation and static backgrounds, may also include an electronic display for illuminating the mechanical animation or background. The electronic display allows the artwork's image to be combined with electronic images. This combination of images allows for the easy changing of the overall appearance of the artwork section 130 without the need to physically remove and replace the static images or mechanical animations. The classical artwork retains the traditional appearances associated with fine furniture and art, however, the modern electronic display offers a variety of appearances that may be traditional, modern, or a combination of these styles.

FIG. 3 shows an alternate embodiment of an artwork section 300 with an electronic display. Artwork section 300 may be associated with the artwork section 130 of FIGS. 1 and 2, or can be a stand-alone piece of art such as a framed painting, print or other artistic creation. This embodiment 300 includes a mechanical animation 320, a background image 310, and a backlit electronic display 340 for projecting an image upon the background image 310. Background image 310 may be a transparent material that allows light to shine through and illuminate the background image 310, and other image layers and objects relatively forward (i.e., disposed further toward a front-most face of the artwork section 300 closest to viewers) of the backlit electronic display 340. The backlit electronic display 340 includes a light source for emitting the light directed in the relatively forward direction. The light source can include LED or other illumination sources that can be selectively activated to emit the light necessary to backlight the backlit electronic display 340, and optionally project light forward to illuminate portions of at least one of the background image and the other relatively-forward objects. Other embodiments of the backlit electronic display 340 can optionally not be backlit in the traditional sense, but instead otherwise illuminated by an internal light source (e.g., LED bulb or array, compact fluorescent bulb or array, etc. . . . ), and the light emitted by this source can be directed forward, to backlight other forward objects.

Mechanical animation 320 may be be similar to the mechanical animation 220 of the rocking sailing ship shown in FIG. 2, for example. However, mechanical animation 300 could be, for example, men sawing wood, a moon dial that rotates with a lunar period (i.e., completes a full lunar cycle) of approximately 30 days, horses galloping in a field and is not limited to the depictions in the figures or descriptions in this document. And as mentioned above, movement of the mechanical animation 320 can be achieved through the use of any desired mechanical, electrical, or electromechanical actuator or driver.

Background image 310 may be a dithered pattern of dots, like bus signage, creating a decorative surface that is visible when observed from the front but is at least partially transparent to light emitted by the backlit electronic display 340, allowing such light to show or shine through the background image 310. Alternatively, background image 310 may include dithered or transparent inks for allowing light emitted by the backlit electronic display 340 through the image, background, or layer. Further, the background image 310 could be a piece of thin molded plastic with a brush stroke surface texture to simulate oil painting. The dithered or transparent inks may be applied over the thin molded plastic. Background image 310 may have the appearance of the background image 210 of FIG. 2, or any appearance to create a desired artistic effect.

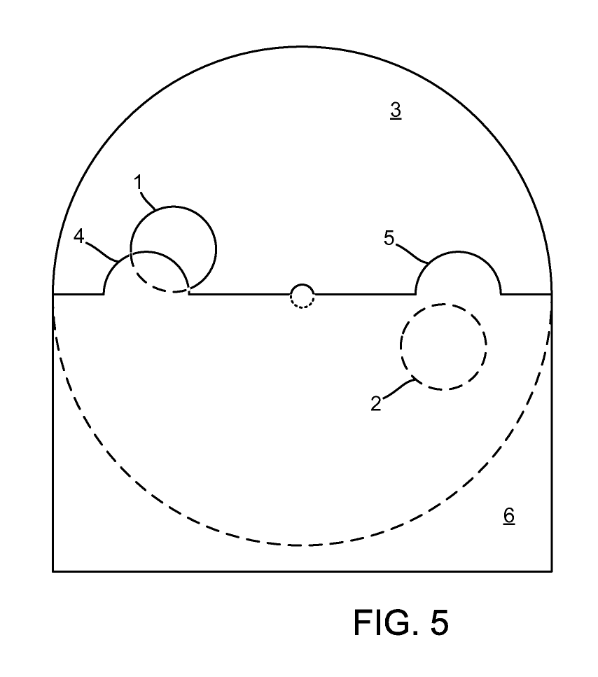

According to alternate embodiments, the background display 310 may be a liquid crystal display (LCD) screen, plasma screen, or cathode ray tube and may be a digital or analog device. The background display 310 may display various images, such as, a moon in the night sky, sun in a day light sky, weather pattern (rain, snow, lightning, and clouds) in a sky. Special effects like sea serpents, meteors, fireworks on the 4th of July, Santa Claus near the Christmas holiday, flying witches at Halloween time, and other effects may also be displayed. Embodiments displaying a moon or other lunar features can be utilized instead of a mechanical lunar animation such as that described above, thereby eliminating the need for the mechanical moon dial described with reference to FIG. 5. Such a display, regardless of whether it is created with a LCD or plasma screen, projected image, etc. . . . , can include a computer-generated graphic having an appearance resembling the moon or other object desired to be represented in the background display. Rather than simply displaying only the phase of the moon as does the mechanical moon dial 3 in FIG. 5, the computer-generated moon can be displayed in any phase such as full, half, and all other partial phases. Additionally, the position of the digital, computer-generated moon displayed by the present embodiment can be adjusted as a function of time to scan the night sky over a period of about 12 hours, approximating the apparent position of the actual moon in the sky over the same time period.

An optional foreground image 330 may be included in artwork 300. For example, foreground image 330 may depict waves or other painted or printed images. Typically these images are static, however they may also be animated to move in a manner similar to the mechanically animated object described above. Additionally, foreground images may be transparent, whether used with background electronic displays or front projection systems.

FIG. 4 shows another embodiment of a piece of artwork 400 with an electronic display. Artwork 400 may be associated with artwork section 130 of FIGS. 1 and 2 or with the piece of artwork 300 of FIG. 3. This embodiment includes a mechanical animation 420, a background image 410, and front projection electronic display 440. Optionally, FIG. 4 may also include a foreground image 430.

This embodiment may not require a background image 430 that is transparent because the computer-generated image is projected from the front of the image by a projector 440. However, a transparent image may be used. Additionally, the image may be projected onto the foreground image 430 as well as the mechanical animation 420, and can be adjusted in real time to create an appearance that reflects or complements movement of the mechanically animated object 420.

The electronic display projector (electronic projector 440) may be placed within the cabinet and/or fascia of the artwork case. For instance, the projector 440 can be supported within a cabinet of the tall clock 110, for example, and oriented to project the computer-generated image onto at least one of the foreground image 230, the background image 210 and the clock dial 120 (e.g., project numbers indicating hours and/or minutes, or a decorative aspect) at an angle onto the background screen 410.

According to another embodiment, the backlighting electronic display 340 for background display with the front projection electronic display 440 for a combination of background illumination and foreground projection.

The location of the artwork 300 and 400 and artwork section 130 that includes at least one of a mechanical animation and a computer-generated image displayed by a source such as the backlit electronic display 340 or the projector 440, are not meant to be limited to placement on a tall clock 110 or other time keeping piece. Rather, artwork, and portions thereof, as well as any object where an aesthetic design including at least one of the animated object and a background image is desired is included within the scope of the present disclosure. Further, the source of the computer-generated images is described herein as displaying an animated object, but the source can be utilized to display the background and/or foreground image(s), either alone or in combination with the animated object.

Controller

Embodiments 300 and 400 may further include a controller for controlling the electronic display (either electronic projector 440 or background electronic display 340). The controller may include a computer processor programmed with a calendar algorithm and timer, for example, to keep track of the current date and control the electronic images based on the date. For example, fireworks may be included in the image on the fourth of July and images of Santa Claus may be included on Christmas. Halloween could include images of ghosts and witches. Optionally, astronomical events could be incorporated into the calendar algorithm. Dates and other events to be depicted can be stored in a non-transitory computer memory provided to the tall clock 110 or other artwork. This may allow the controller to adjust the phase of the moon depicted in the artwork, either by adjusting an electronic image of the moon or controlling the mechanical animation that depicts the moon. In another optional embodiment, a network connection or radio signal receiver could be used to synchronize current events such as weather with the projected image. Thus, the events could be received over the computer network (e.g., the Internet) to affect the appearance of the display generated by the sources such as the backlit electronic display 340 and the projector 440, for example, rather than (or in addition to) being stored in the computer memory. The computer-generated images displayed by the backlit electronic display 340 and the projector 440 can optionally be related to the geographic location where the tall clock 110 or other object with the artwork is on display. For instance, the images generated for a tall clock located in Florida can reflect a beach theme, while the images generated for a tall clock located in Colorado can reflect a mountainous theme.

The controller may also be able to synchronize electronic images with the movement of the mechanical animation. For example, with back lit electronic displaying, as depicted by background electronic display 340, the rocking ship of 2 (mechanical animation 220) could be perfectly outlined with light as it rocks on the ocean. Alternatively, with a front projection screen, as depicted by electronic projector 440, the rocking ship of FIG. 2 may be projected with registration numbers, shadows that indicate the fluttering of the sails in a light wind, or a pirate ship motif for a Halloween party.

The controller may further include a menu option, for projecting a menu with the electronic projector that allows a user to optionally select images in a database, adjust the timing of projected images, change the data and time in the timer, select different calendar algorithms to conform with the user's tastes and customs. The controller may further include the memory for storing digital images, user selections, calendar algorithms, and other information. The memory may be one or more of, a hard drive and random access memory.

The controller may further control the mechanical animations 320/420 movement and/or sense the movement or position of these animations and utilize this information of the position of the animation to adjust the display of visual images or effects from the electronic display.

In another embodiment, the controller may also sense input from an imager (e.g. digital camera) that detects changes in the position of the mechanical animation 320/420. Additionally, the imager may be used to sense image changes of the background images, the foreground images, and the mechanical animation. For example, a user may physically change the mechanical animation (e.g. rocking ship) shown in FIG. 2 to a moon or another ship and this change would be imaged by the imager and then sensed by the controller which may automatically adjust the electronic images displayed on the artwork to reflect such changes.

In still another embodiment, the controller may be used to control chimes, including digital chimes with a variety of tunes and may further include day/night quiet control. The controller may also control mechanical clock functions such as winding a clock or synchronizing a clock with a digital clock or external time signal. Additionally, the controller may include the ability to turn off the electronic projection to render a more tradition image without the use of electronic displays.

In yet another embodiment, the controller may be interfaced with external devices for programming or allowing a user to select options, preferences, and images for display by the display.

A method for displaying an electronic image (e.g. digital electronic image) on a background image with a mechanical animation may include: moving the mechanical animation at least partially in front of the background image. The method also including: displaying the electronic image on the background image, sensing the position of the mechanical animation, and adjusting said displayed electronic image in accordance with said sensed position. The method may also include: adjusting the digital image based on a calendar algorithm in a controller that controls the digital image. The method may optionally include sensing the location of the mechanical animation and displaying an image on the background image and mechanical image according to the position of the mechanical animation.

Illustrative embodiments have been described, hereinabove. It will be apparent to those skilled in the art that the above devices and methods may incorporate changes and modifications without departing from the general scope of this invention. It is intended to include all such modifications and alterations within the scope of the present invention. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An apparatus for projecting an electronic image comprising:
at least one of a static image and a mechanically-animated object disposed within a framed region;
an electronic display device for displaying a computer-generated image adjacent to the at least one of the static image and the mechanically-animated object within the framed region to establish an artistic composition, wherein the computer-generated image comprises content that is related to, and supplements content included in the at least one of the static image and the mechanically-animated object to provide an adaptable context to the at least one of the static image and the mechanically-animated object; and
a controller for controlling the images of the electronic display.

2. The apparatus according to claim 1, wherein the computer-generated image establishes a background with an adaptable appearance behind the at least one of the static image and the mechanically-animated object when viewed by an observer.

3. The apparatus according to claim 2, wherein the adaptable appearance comprises an animation that changes over a period of time to reflect a change of an environmental condition over the period of time.

4. The apparatus according to claim 3, wherein the environmental condition comprises a lunar phase, and the animation comprises a lunar animation that varies an appearance of a computer-generated moon to reflect changes in the lunar phase.

5. The apparatus according to claim 1, wherein the electronic display device projects the computer-generated image through a background comprising the at least one of the static image and the mechanically-animated object.

6. The apparatus according to claim 1, wherein the static image establishes a fixed background on which the computer-generated image is to be displayed.
